(19) United States
(12) Patent Application Publication
(10) Pub. No.: US 2025/0196147 A1
(43) Pub. Date: Jun. 19, 2025

(54) SMART FUME HOOD

(71) Applicant: BIOGREAT CO., LTD., Taoyuan City (TW)

(72) Inventor: Bing-Long HO, Taoyuan City (TW)

(21) Appl. No.: 18/975,929

(22) Filed: Dec. 10, 2024

(30) Foreign Application Priority Data
Dec. 15, 2023 (TW) 112213750

(51) Int. Cl. B01L 5/02

(52) U.S. Cl. CPC B01L 5/02; B01L 2300/022; B01L 2300/0627

(57) ABSTRACT

A smart fume hood is used for extracting the experimental waste gas generated by an experimental liquid and is electrically connected to a blockchain network. The smart fume hood includes a fume hood, a chipset, and a detection module. The fume hood includes an experimental tank, a moving door, and a peristaltic pump. The experimental tank is used for holding the experimental liquid. The moving door is movably connected to the experimental tank. The peristaltic pump is connected to the experimental tank and used for extracting the experimental waste gas. The chipset is located in the fume hood and includes a blockchain information tracking part. The blockchain information tracking part is electrically connected to the blockchain network and used for recording the source and logistics information of the experimental liquid on the blockchain network for tracing.

### CROSS REFERENCE TO RELATED APPLICATIONS

This application claims priority of application No. 112213750 filed in Taiwan on Dec. 15, 2023 under 35 U.S.C. § 119, the entire contents of both of which are hereby incorporated by reference.

### BACKGROUND OF THE INVENTION

### 1. Field of the Invention

The present invention relates to a smart fume hood, particularly a smart fume hood that facilitates tracing the source of an experimental liquid and detecting the gas property of experimental waste gas.

### 2. Description of the Related Art

A fume hood is a large piece of equipment in a chemical laboratory. A fume hood includes an exhaust fan, and the exhaust fan is used for extracting the harmful gases generated when an experimenter uses chemical liquids in experiments, preventing exposure of the experimenters to the harmful gases and thereby protecting their health.

However, existing fume hoods only have the function of extracting gases, making their functionality relatively single-purpose. Therefore, there is a need to provide a fume hood integrating internet technology to offer more diversified functions or applications.

### SUMMARY OF THE INVENTION

The object of the present invention is to provide a smart fume hood that facilitates tracing the source of an experimental liquid and detecting the gas property of experimental waste gas.

To achieve the abovementioned object, a smart fume hood of the present invention is used for extracting an experimental waste gas generated by an experimental liquid and is electrically connected to a blockchain network. The smart fume hood includes a fume hood, a chipset and a detection module. The fume hood includes an experimental tank, a moving door and a peristaltic pump. The experimental tank is used for holding the experimental liquid. The moving door is movably connected to the experimental tank. The peristaltic pump is linked to the experimental tank and used for extracting the experimental waste gas. The chipset is located in the fume hood. The chipset includes a blockchain information tracking part. The blockchain information tracking part is electrically connected to the blockchain network and used for recording a source of the experimental liquid and logistics information of the experimental liquid on the blockchain network for traceability. The detection module is located in the fume hood and electrically connected to the chipset, and the detection module is used for measuring at least one gas property of the experimental waste gas.

According to one embodiment of the present invention, the chipset further includes a positioning part, and the positioning part is used for positioning the smart fume hood.

According to one embodiment of the present invention, the chipset further includes a temperature detector, and the temperature detector is used for detecting a temperature of the smart fume hood.

According to one embodiment of the present invention, the chipset further includes a Radio Frequency Identification (RFID) tag, and the RFID tag records an information of the smart fume hood in a form of Radio Frequency Identification.

According to one embodiment of the present invention, the smart fume hood further includes a wireless module, and the wireless module is located in the fume hood and electrically connected to the chipset, the detection module and an external computer.

According to one embodiment of the present invention, the smart fume hood further includes a battery, and the battery is located in the fume hood and used for providing power to the chipset, the detection module and the wireless module.

According to one embodiment of the present invention, the smart fume hood further includes a screen, and the screen is located in the fume hood and electrically connected to the chipset, the detection module and the battery.

According to one embodiment of the present invention, the detection module, the chipset, the detection module, the wireless module, the battery and the screen are located in the experimental tank.

According to one embodiment of the present invention, the positioning part is a Global Positioning System (GPS) chip.

### BRIEF DESCRIPTION OF THE DRAWINGS

FIG. 1 is a schematic diagram of the smart fume hood in one embodiment of the present invention.

FIG. 2 is a system structure diagram of the smart fume hood, external computer, RFID tag reader, and blockchain network of one embodiment of the present invention.

### DETAILED DESCRIPTION OF THE PREFERRED EMBODIMENT

To better understand the technical content of the present invention, the following description provides a detailed explanation of the preferred embodiment.

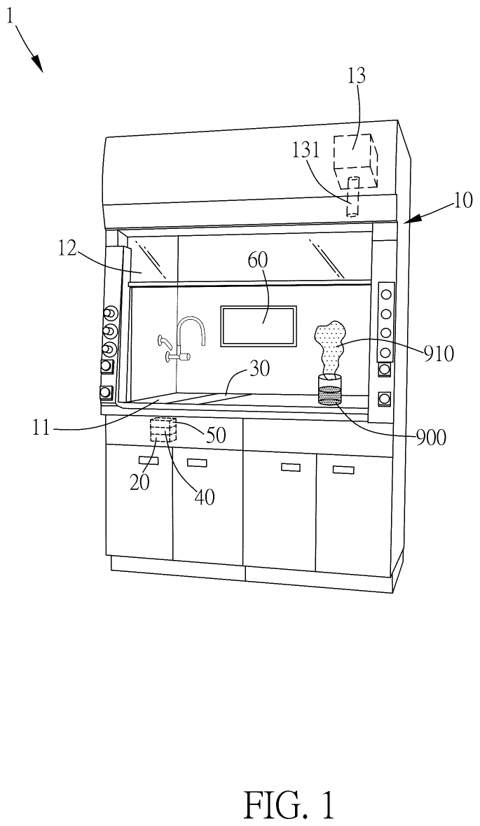

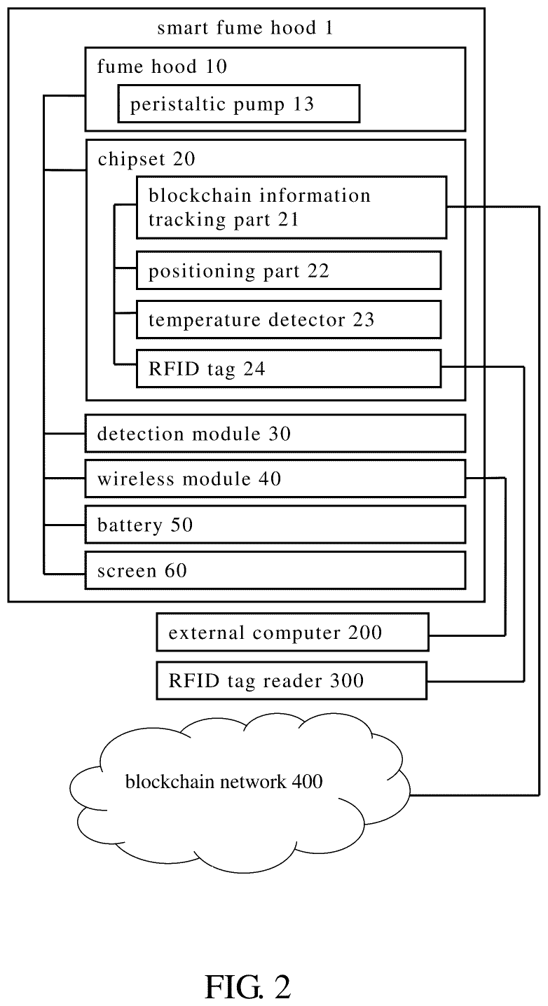

Please refer to FIG. 1 and FIG. 2 for the smart fume hood in one embodiment of the present invention. FIG. 1 is a schematic diagram of the smart fume hood in one embodiment of the present invention. FIG. 2 is a system structure diagram of the smart fume hood, external computer, RFID tag reader, and blockchain network of one embodiment of the present invention.

As shown in FIG. 1 and FIG. 2, in one embodiment of the present invention, the smart fume hood 1 is designed to trace the source of the experimental liquid and detect the properties of the experimental waste gas. The smart fume hood 1 is used for holding an experimental liquid 900 and extracting an experimental waste gas 910 generated by the experimental liquid 900, and the smart fume hood 1 is electrically connected to an external computer 200 and a blockchain network 400 to transmit relevant information about the smart fume hood 1 and the contained experimental liquid 900 to the external computer 200 and blockchain network 400. The experimental liquid 900 is a chemical liquid that volatilizes to generate the experimental waste gas 910. In this embodiment, the experimental liquid 900 is, for example, ammonia, which volatilizes to generate ammonia gas as the experimental waste gas 910 with a pungent smell. However, the type of experimental liquid 900 is not limited to this example and can be changed according to actual use requirements. The external computer 200 can be a desktop or laptop computer used for data transmission with the smart fume hood 1. The blockchain network 400 is an external network system that uses blockchain technology to create and store data chains.

In one embodiment of the present invention, the smart fume hood 1 includes a fume hood 10, a chipset 20, a detection module 30, a wireless module 40, a battery 50, and a screen 60. The fume hood 10 is a cabinet with ventilation functionality which is used for allowing the user to place the experimental liquid 900 and extract the experimental waste gas 910 generated by the experimental liquid 900. The fume hood 10 includes an experimental tank 11, a moving door 12, and a peristaltic pump 13. The experimental tank 11 is used for allowing the user to place containers such as beakers or test tubes filled with the experimental liquid 900. The chipset 20, the detection module 30, the wireless module 40, the battery 50, and the screen 60 are located in the experimental tank 11; the detection module 30 is located on the bottom surface of the experimental tank 11. The moving door 12 is made of transparent glass or acrylic and can be moved to connect with the experimental tank 11. The moving door 12 is used for closing the experimental tank 11 with an airtight seal to prevent the experimental waste gas 910 from escaping into the local environment. The peristaltic pump 13 includes a ventilation duct 131 linked to the experimental tank 11. The peristaltic pump 13 is electrically connected to the detection module 30 and is used for extracting the experimental waste gas from the experimental tank 11 and transferring the experimental waste gas to an external gas filtration chamber before it is discharged into the atmosphere. This allows the experimental waste gas 910 to be filtered into harmless gas so as to prevent the experimental waste gas 910 from being inhaled by laboratory personnel and affecting their health.

In one embodiment of the present invention, the chipset 20 is located in the experimental tank 11 of the fume hood 10. The chipset 20 includes a blockchain information tracking part 21, a positioning part 22, a temperature detector 23, and an RFID tag 24. The blockchain information tracking part 21 is a computing chip that is electrically connected to a blockchain network 400 to transmit and record data on the blockchain network 400, as well as to trace previously recorded data; for example, the blockchain information tracking part 21 can record the source and logistics information of the experimental liquid 900 on the blockchain network 400, and by leveraging the traceable and tamper-resistant features of blockchain technology, the source and logistics information of the experimental liquid 900 can be accurately recorded and tracked. The blockchain information tracking part 21 can also trace the source and logistics information of the experimental liquid 900 recorded on the blockchain network 400. In one embodiment of the present invention, the source of the experimental liquid 900 may include chemical laboratories or pharmaceutical companies. The logistics information of the experimental liquid 900 includes the location where it was obtained, the transportation process, and the locations of production and storage, among other details. Additionally, the source and logistics information of the experimental liquid 900 can be input into the blockchain information tracking part 21 via an external computer 200, which then records this information on the blockchain network 400. This use of blockchain's traceable and tamper-resistant characteristics allows for the clear recording and management of the source and logistics information of the experimental liquid 900. The positioning part 22 is a Global Positioning System (GPS) chip used for positioning the smart fume hood 1 so as to determine the current location of the smart fume hood 1. The temperature detector 23 is a chip with temperature sensing function and is used for detecting the temperature of the smart fume hood 1, thereby monitoring whether it is in an appropriate temperature range to prevent environmental conditions from affecting the quality of the experimental liquid 900. The RFID tag 24 records information about the smart fume hood 1 and/or the experimental liquid 900 using the Radio Frequency Identification method. This information may include the manufacture date of the smart fume hood 1, the date and location of experiments conducted with the experimental liquid 900, the type of experimental liquid 900, and more. The information recorded by the RFID tag 24 can be entered via the external computer 200. However, the recorded information is not limited to the above examples and can be adjusted according to design requirements. The information stored in the RFID tag 24 can also be read by an external RFID tag reader 300 using radio signals. However, as RFID tag readers are widely used in the field of wireless radio frequency technology and are not the main focus of this invention, there is no need for further description.

In one embodiment of the present invention, the detection module 30 is located on the bottom surface of the experimental tank 11 and is electrically connected to the chipset 20. The detection module 30 is a chip with the function of measuring gas properties and is used for measuring at least one gas property of the experimental waste gas 910. These properties may include pH, pressure, density, humidity, and others. The user can place containers which contain the experimental liquid 900 directly on the detection module 30, allowing for close-range detection. Via the measuring gas properties function of the detection module 30, the detection module 30 can check the status of gases within the experimental tank 11. For example, if the experimental waste gas 910 is an acidic gas (such as hydrogen sulfide), the detection module 30 can determine whether the experimental waste gas 910 remains in the experimental tank 11 or has been fully extracted based on the detected pH levels. If the detection module 30 detects that the gas inside the experimental tank 11 is still acidic, it indicates that acidic experimental waste gas 910 remains in the experimental tank 11. In such cases, the detection module 30 can send an extraction command signal to the peristaltic pump 13 so that the peristaltic pump 13 will continue extracting the experimental waste gas 910 until it is completely removed from the experimental tank 11. However, the types of gas properties that the detection module 30 can measure are not limited to the aforementioned examples and can be adjusted according to actual needs.

In one embodiment of the present invention, the wireless module 40, such as a network chip, is located in the experimental tank 11 of the fume hood 10 and is electrically connected to the chipset 20, detection module 30, and external computer 200. The wireless module 40 is used for transmitting the information measured by the chipset 20 and the detection module 30 to the external computer 200, allowing the user to operate the external computer 200 to inspect the data related to the experimental liquid 900 contained in the smart fume hood 1, such as the source and logistics information of the experimental liquid 900 and the gas properties of the experimental waste gas 910.

In one embodiment of the present invention, the battery 50 is located in the experimental tank 11 of the fume hood 10 and provides power to the chipset 20, the detection module 30, the wireless module 40, and the screen 60, ensuring the proper functioning of the chipset 20, detection module 30, and wireless module 40.

In one embodiment of the present invention, the screen 60 is located on the wall of the experimental tank 11 in the fume hood 10. The screen 60 is electrically connected to the chipset 20, the detection module 30, and the battery 50. The screen 60 is used for displaying the information processed and detected by the chipset 20 and detection module 30 such that when the user is conducting experiments using the smart fume hood 1, the user can look at the screen 60 on the wall of the experimental tank 11 to see the information processed and provided by the chipset 20 and detection module 30.

As shown in FIG. 1 and FIG. 2, when the user uses the smart fume hood 1 of the present invention to conduct experiments with the experimental liquid 900, the user can pour the experimental liquid 900 into a beaker or test tube and place it in the experimental tank 11. The detection module 30 will measure the gas properties of the experimental waste gas 910 inside the experimental tank 11, such as pH, pressure, density, humidity, etc. Detection of the gas properties through the detection module 30 can allow determination of whether the experimental waste gas 910 is still present in the experimental tank 11 or has been extracted to the outside. The user can close the experimental tank 11 with the moving door 12 to seal the fume hood 10 and isolate the experimental waste gas 910 from the external environment, thereby preventing pollution caused by the spread of the experimental waste gas 910.

Furthermore, the positioning part 22 is used for positioning the smart fume hood 1 to ensure that its current position is known. The temperature detector 23, which is a chip with temperature sensing capability, is used for detecting the temperature of the smart fume hood 1. This allows monitoring of the smart fume hood 1 to ensure it is at an appropriate temperature, thereby preventing extreme heat or cold from affecting the quality of the experimental liquid 900.

Furthermore, the user can operate the external computer 200 to access the wireless module 40 of the smart fume hood 1 to enter information about the smart fume hood 1 and/or the experimental liquid 900 into the RFID tag 24. This information may include the manufacturing date of the smart fume hood 1, the dates and locations of experiments involving the experimental liquid 900, the type of experimental liquid 900, and more. This setup enables the recording of information about the smart fume hood 1 and the experimental liquid 900 in the RFID tag 24 such that the user can use an RFID tag reader 300 to quickly access recorded information about the smart fume hood 1 and the experimental liquid 900.

Furthermore, the user can operate the external computer 200 to input the source and logistics information of the experimental liquid 900 into the blockchain information tracking part 21. The blockchain information tracking part 21 then records the source and logistics information of the experimental liquid 900 onto the blockchain network 400. Via the function of tracing the logistics information of items via the blockchain, the source of the experimental liquid 900, the location where it was obtained, the places of its production and storage, and its transportation process can all be recorded in the blockchain network 400. This setup allows for clear recording and management of the experimental liquid 900's source and logistics information by utilizing the blockchain's traceability and resistance to tampering. Consequently, if the experimental liquid 900 is found to have issues (such as contamination or degradation), the user can quickly trace its source and logistics information using the blockchain's tracing function and thereby determine if the source or a logistics factor has caused the contamination or degradation.

The design of the smart fume hood 1 in the present invention offers a diverse and convenient range of functions. These include tracing the source and logistics information of the experimental liquid, positioning the smart fume hood 1 to determine its current position, detecting the temperature of the smart fume hood 1 to monitor if it is at an appropriate temperature, using RFID to record information about the experimental liquid and smart fume hood 1 for quick data retrieval by the user, and measuring the gas properties of the experimental waste gas.

It should be noted that the above is merely an embodiment and not a limitation thereof. For example, any modifications that do not depart from the basic framework of the present invention should fall within the claimed scope of this patent, and the patent claims shall govern.

What is claimed is:

1. A smart fume hood, used for extracting an experimental waste gas generated by an experimental liquid and electrically connected to a blockchain network, the smart fume hood comprising:
a fume hood, comprising:
an experimental tank, used for holding the experimental liquid;
a moving door, movably connected to the experimental tank; and
a peristaltic pump, linked to the experimental tank and used for extracting the experimental waste gas;
a chipset, located in the fume hood, wherein the chipset comprises a blockchain information tracking part, and the blockchain information tracking part is electrically connected to the blockchain network and used for recording a source of the experimental liquid and logistics information of the experimental liquid on the blockchain network for traceability; and
a detection module, located in the fume hood and electrically connected to the chipset, wherein the detection module is used for measuring at least one gas property of the experimental waste gas.

2. The smart fume hood as claimed in claim 1, wherein the chipset further comprises a positioning part, and the positioning part is used for positioning the smart fume hood.

3. The smart fume hood as claimed in claim 2, wherein the chipset further comprises a temperature detector, and the temperature detector is used for detecting a temperature of the smart fume hood.

4. The smart fume hood as claimed in claim 3, wherein the chipset further comprises an RFID tag, and the RFID tag records an information of the smart fume hood in a form of Radio Frequency Identification.

5. The smart fume hood as claimed in claim 4, further comprising a wireless module, and the wireless module is located in the fume hood and electrically connected to the chipset, the detection module and an external computer.

6. The smart fume hood as claimed in claim 5, further comprising a battery, and the battery is located in the fume hood and used for providing power to the chipset, the detection module and the wireless module.

7. The smart fume hood as claimed in claim 6, further comprising a screen, and the screen is located in the fume hood and electrically connected to the chipset, the detection module and the battery.

8. The smart fume hood as claimed in claim 7, wherein the detection module, the chipset, the wireless module, the battery and the screen are located in the experimental tank.

9. The smart fume hood as claimed in claim 8, wherein the positioning part is a Global Positioning System (GPS) chip.
